(19) United States
(12) Patent Application Publication
(10) Pub. No.: US 2024/0298146 A1
(43) Pub. Date: Sep. 5, 2024

(54) SYSTEMS AND METHODS FOR REPORTING LOCATION BY A FIRST MONITOR DEVICE BASED IN PART ON MOVEMENT OF A SECOND MONITOR DEVICE

(71) Applicant: BI Incorporated, Boulder, CO (US)

(72) Inventors: Duke Hanson, Boulder, CO (US); Todd Bischoff, Boulder, CO (US)

(73) Assignee: BI Incorporated, Boulder, CO (US)

(21) Appl. No.: 18/432,071

(22) Filed: Feb. 5, 2024

Related U.S. Application Data
(60) Provisional application No. 63/449,921, filed on Mar. 3, 2023.

(51) Int. Cl. H04W 4/029; H04W 4/02

(52) U.S. Cl. CPC H04W 4/029; H04W 4/023; H04W 4/027

(57) ABSTRACT

Various embodiments provide systems and methods for using prior location information in a first monitor device for reporting when no significant movement is indicated by a second monitor device.

### CROSS REFERENCE TO RELATED APPLICATIONS

The present application claims priority to (is a non-provisional application of) U.S. Pat. App. No. 63/449,921 entitled “Systems and Methods for Reporting Location Information including Reporting of no Significant Position Change”, and filed Mar. 3, 2023 by Hanson et al. The entirety of the aforementioned reference is incorporated herein by reference for all purposes.

### BACKGROUND OF THE INVENTION

Various embodiments provide systems and methods for using prior location information in a tracking device for reporting when no significant movement is indicated.

Tracking devices have been associated with monitored individuals and provide an ability to automatically determine the location of the respective monitored individual. Such tracking devices can include, for example, location determination circuit. Such location determination circuit depends upon, for example, signal reception from location satellites, WiFi devices, and/or transmitting beacons. Such location determination circuitry can be costly in terms of power consumption, and yet remains active even when the tracking device is not moving and thus not providing meaningful location information.

Thus, for at least the aforementioned reasons, there exists a need in the art for more advanced approaches, devices and systems for updating location information in a more power efficient manner.

### BRIEF SUMMARY OF THE INVENTION

Various embodiments provide systems and methods for using prior location information in a tracking device for reporting when no significant movement is indicated.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIGS. 1a-1d are block diagrams illustrating a location monitoring system that includes a user attached monitoring device having location determination circuit, movement determination circuitry, and location information replacement functionality in accordance with various embodiments;

FIGS. 2a-2c are block diagrams illustrating a location monitoring system that includes a user detached monitoring device having location determination circuit, movement determination circuitry, and location information replacement functionality in accordance with some embodiments;

FIG. 3 is a block diagram of a location monitoring system including a hybrid monitoring system having a user detached monitor device, a user attached monitor device, and location information replacement functionality in accordance with various embodiments;

FIGS. 4a-4b are flow diagrams showing a method in accordance with some embodiments for reporting location information in a scenario where a monitoring device indicates it has not moved significantly;

FIGS. 5 and 6a-6b are flow diagrams showing a method in accordance with various embodiments for reporting location information by one monitoring device in a hybrid monitoring system based at least in part on an indication of insignificant movement from another monitoring device in the hybrid monitoring system; and

FIG. 7 shows an example processing system that may be used in relation to various embodiments.

### DETAILED DESCRIPTION OF THE INVENTION

Various embodiments provide systems and methods for using prior location information in a tracking device for reporting when no significant movement is indicated.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “cell” includes reference to one or more of such cells.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the elements shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

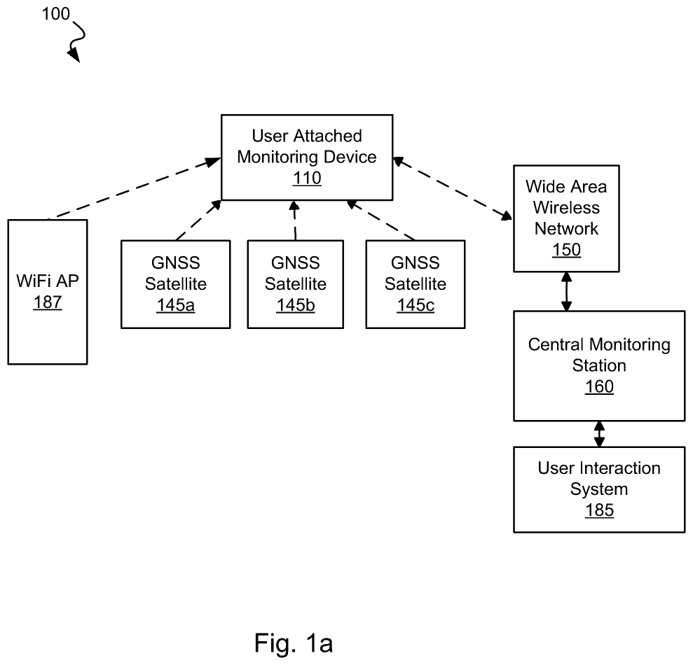

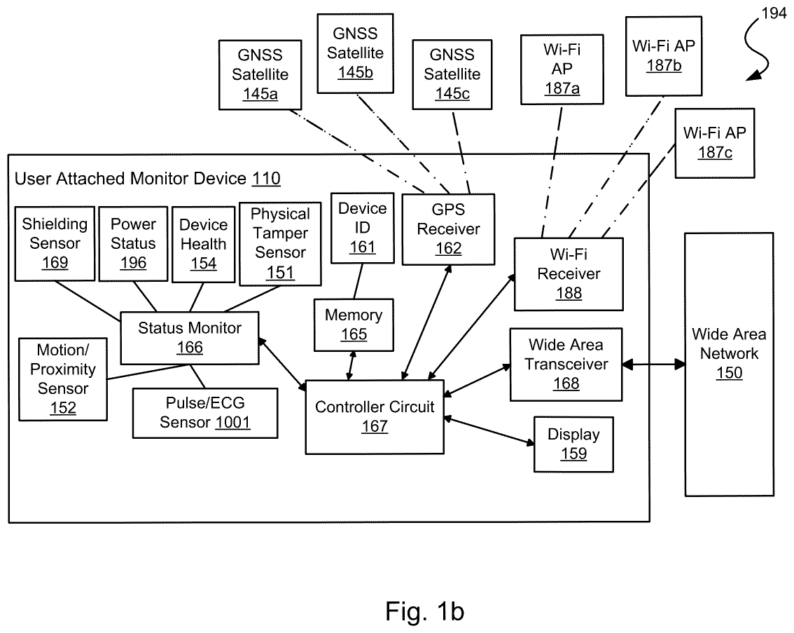

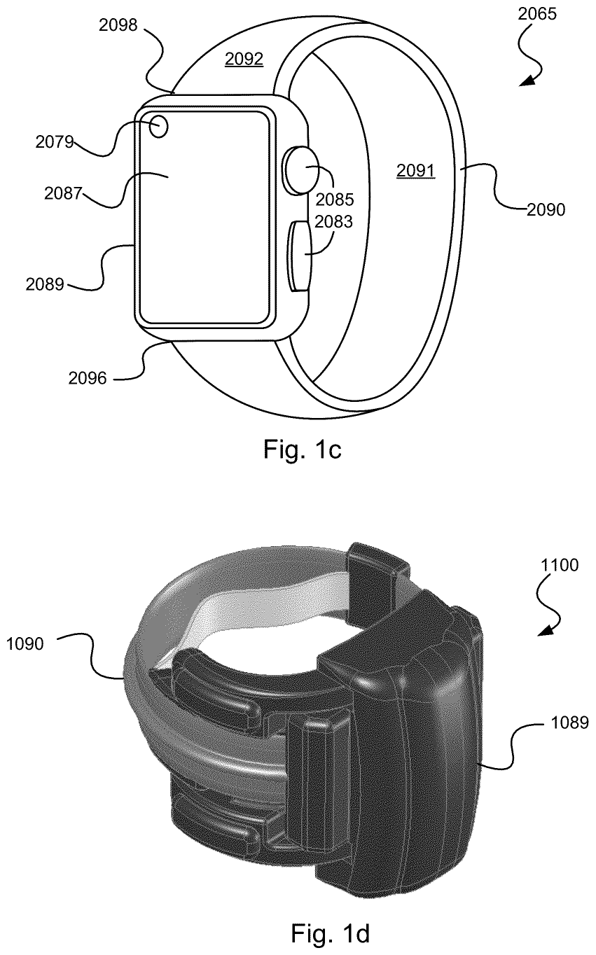

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Various embodiments provide tracking systems that include: a first monitor device and a second monitor device. The first monitor device includes a movement determination circuit configured to generate an insignificant movement indication when the first monitor is moving less than a defined amount. The second monitor device includes: a location determination circuit configured to determine a location of the second monitor device, a transmitting circuit; and a controller circuit. The controller circuit is configured to: transmit the location to a receiving device using the transmitting circuit; after transmitting the location to the receiving device, receive the insignificant movement indication from the first monitor device. Based at least in part upon the insignificant movement indication, the controller circuit is further configured to: reduce power consumption of the location determination circuit; and re-transmit the location to the receiving device using the transmitting circuit.

In some instances of the aforementioned embodiments, the first monitor device is a user attached monitor device and the second monitor device is a user detached monitor device. In some such instances, the user attached monitor device further includes a tamper detection circuit configured to detect removal of the user attached monitor device from the individual. In various such instances, the user attached monitor device further includes a tamper detection circuit configured to detect removal of the user attached monitor device from the individual. In other instances of the aforementioned embodiments, the first monitor device is a user detached monitor device and the second monitor device is a user attached monitor device. In some such instances, the user attached monitor device further includes a tamper detection circuit configured to detect removal of the user attached monitor device from the individual. In various such instances, the user attached monitor device further includes a tamper detection circuit configured to detect removal of the user attached monitor device from the individual.

In various instances of the aforementioned embodiments, the movement determination circuit includes an accelerometer. In some cases, the insignificant movement indication indicates that the first monitor device has moved less than a defined distance in a time period. In some such cases, the defined distance is less than fifty feet. In some instances of the aforementioned embodiments, the location determination circuit is includes one or more of: a satellite-based position circuit, and/or a WiFi-based position circuit.

Other embodiments provide methods for tracking an individual. Such methods include: receiving a location of a first monitor device from a location determination circuit in the first monitor device; transmitting the location to a receiving device; after transmitting the location, receiving an insignificant movement indication from a movement determination circuit in a second monitor device. Based at least in part upon the insignificant movement indication, the methods further include: reducing power consumption of the location determination circuit; and re-transmitting the location to the receiving device.

Yet other embodiments provide tracking systems that include: a first monitor device and a second monitor device. The first monito device includes a movement determination circuit configured to generate an insignificant movement indication when the first monitor is moving less than a defined amount. The second monitor device includes: a location determination circuit configured to determine a location of the second monitor device; a transmitting circuit; a processor, and a computer readable medium communicatively coupled to the processor. The computer readable medium includes instructions which, when executed by the processor, cause the processor to: transmit the location to a receiving device using the transmitting circuit; after transmitting the location to the receiving device, receive the insignificant movement indication from the first monitor device; and based at least in part upon the insignificant movement indication: reduce power consumption of the location determination circuit; and re-transmit the location to the receiving device using the transmitting circuit.

Yet other embodiments provide methods for tracking an individual. Such methods include: receiving a location of a monitoring device from a location determination circuit in the monitoring device; transmitting the location to a receiving device at a first time; after the first time, and receiving an indication of insignificant movement from a movement determination circuit in the monitoring device. Based at least in part upon the indication of insignificant movement, the methods further include: reducing power consumption of the location determination circuit; replacing the indication of insignificant movement with the location; and re-transmitting the location to the receiving device at a second time.

In some instances of the aforementioned embodiments, the movement determination circuit includes an accelerometer. In various instances of the aforementioned embodiments, the indication of insignificant movement indicates that the tracking device has moved less than a defined distance from the location. In some such instances, the defined distance is less than fifty feet. In some instances of the aforementioned embodiments, the location determination circuit includes one or more of: a satellite-based position circuit and/or a WiFi-based position circuit.

In various instances of the aforementioned embodiments, the tracking device is a user attached monitor device secured to the individual. In some cases, the tracking device further includes a tamper detection circuit configured to detect removal of the tracking device from the individual. In some instances of the aforementioned embodiments, the tracking device is a user detached monitor device. In some cases, the user detached monitor device includes a cellular telephone assigned to the monitored individual.

Further embodiments provide monitoring devices that include: a location determination circuit; a transmitting circuit; a movement determination circuit, and a controller circuit. The controller circuit is configured to: receive a location of the tracking device from the location determination circuit; transmit the location to a receiving device using the transmitting circuit; after the first time, receive an indication of insignificant movement from the movement determination circuit. Based at least in part upon the indication of insignificant movement, the controller circuit is further configured to: reduce power consumption of the location determination circuit; and re-transmit the location to the receiving device.

Yet further embodiments provide systems for tracking an individual. Such systems include: a location determination circuit; a transmitting circuit; a movement determination circuit; a processor, and a computer readable medium communicatively coupled to the processor. The computer readable medium includes instructions which, when executed by the processor, cause the processor to: receive a location of a monitor device attached to an individual from the location determination circuit; transmit the location to a receiving device using the transmitting circuit; and after receiving the location, receive an indication of insignificant movement from the movement determination circuit. Based at least in part upon the indication of insignificant movement, the processor is further configured to: reduce power consumption of the location determination circuit; and re-transmit the location to the receiving device.20.

Turning to FIG. 1a, a block diagram illustrates a monitoring system 100 including a user attached monitor device 110 and a central monitoring station 160. Central monitoring station 160 is wirelessly coupled to user attached monitor device 110 via one or more wide area wireless (e.g., cellular telephone network, Internet via a WiFi access point, or the like) communication networks 150.

Central monitoring station 160 may be any location, device and/or system where location data and/or other types of data are received, including by way of non-limiting example: a cellular/smart phone, an email account, a website, a network database, and a memory device. The location data and/or other types of data are stored by central monitoring station 160 and are retrievable by a monitoring individual, such as a parent, guardian, parole officer, court liaison, spouse, friend, or other authorized group or individual. In this manner, the monitoring individual is able to respond appropriately to detected activity of a monitored individual. In some cases, the monitoring individual is able to retrieve the location data and/or other data types via a user interaction system 185 which may be, but is not limited to, a network connected user interface device communicatively coupled via a network to central monitoring station 160 and/or directly to user attached monitor device 110 via wide area wireless network 150.

Central monitoring station 160 may include a server supported website, which may be supported by a server system comprising one or more physical servers, each having a processor, a memory, an operating system, input/output interfaces, and network interfaces, all known in the art, coupled to the network. The server supported website comprises one or more interactive web portals through which the monitor may monitor the location of the monitored individual in accordance with the described embodiments. In particular, the interactive web portals may enable the monitor to retrieve the location and user identification data of one or more monitored individuals, set or modify ‘check-in’ schedules, and/or set or modify preferences. The interactive web portals are accessible via a personal computing device, such as for example, a home computer, laptop, tablet, and/or smart phone.

In some embodiments, the server supported website comprises a mobile website or mobile application accessible via a software application on a mobile device (e.g. smart phone). The mobile website may be a modified version of the server supported website with limited or additional capabilities suited for mobile location monitoring.

User attached monitor device 110 includes a location sensor or location monitoring circuitry that senses the location of user attached monitor device 110 and generates corresponding location data. For example, when user attached monitor device 110 is receiving wireless global navigation satellite system (hereinafter “GNSS”) location information 136, 138, 139 from a sufficient number of GPS or GNSS satellites 145 respectively, user attached monitor device 110 may use the received wireless GNSS location information to calculate or otherwise determine the location of a human subject to which user attached monitor device 110 is attached. Global positioning system (hereinafter “GPS) is one example of a GNSS location system. While GPS is used in the specific embodiments discussed herein, it is recognized that GPS may be replaced by any type of GNSS system. In some instances, this location includes latitude, longitude, and elevation. It should be noted that other types of earth-based triangulation may be used in accordance with different embodiments of the present invention. For example, other cell phone-based triangulation, UHF band triangulation such as, for example, long range (hereinafter “LoRa”) triangulation signals. Based on the disclosure provided herein, one of ordinary skill in the art will recognize other types of earth-based triangulation that may be used. The location data may comprise one or more of, but is not limited to: global positioning system (“GPS”) data, Assisted GPS (“A-GPS”) data, Advanced Forward Link Trilateration (“AFLT”) data, and/or cell tower triangulation data. Where GPS is used, user attached monitor device 110 receives location information from three or more GPS or GNSS satellites 145 via respective communication links 136, 138, 139. The location data and/or other data gathered by user attached monitor device 110 is wirelessly transmitted to central monitoring station 160 via wide area wireless network 150 accessed via a wireless link 135.

Further, user attached monitor device 110 includes WiFi based location determination circuit that is configured to communicate with one or more WiFi access points 187 and based thereon to determine location of user attached monitor device 110.

Turning to FIG. 1b, a block diagram 194 of user attached monitor device 110 is shown in accordance with some embodiments. As shown, user attached monitor device 110 includes a device ID 161 that may be maintained in a memory 165, and is thus accessible by a controller circuit 167. Controller circuit 167 interacts with a GPS receiver 162 (one of many examples of location determination circuit) and memory 165 at times for storing and generating records of successively determined GPS locations (i.e., locations of user attached monitor device 110). Similarly, controller circuit 167 interacts with a WiFi receiver 188 and memory 165 at times for storing and generating records of successively determined WiFi access point identifications and signal strength. In some cases, memory 165 may include instructions (e.g., software-based or firmware-based instructions) executable by controller circuit 167 to perform and/or enable various functions associated with user attached monitor device 110. As user attached monitor device 110 comes within range of one or more WiFi access points (e.g., a WiFi access point 187a, a WiFi access point 187b, and/or a WiFi access point 187c), WiFi receiver 188 senses the signal provided by the respective WiFi access points, and provides an identification of the respective WiFi access point and a signal strength of the signal received from the WiFi access point to WiFi receiver 188. The combination of controller circuit 167 and WiFi receiver 188 is one of many examples of location determination circuit. This information is provided to controller circuit 167 which stores the information to memory 165 (e.g., locations of user attached monitor device 110).

In operation, controller circuit 167 causes an update and reporting of the location of user attached monitor device 110 via a wide area transceiver 168 and wide area communication network 150. In some embodiments, wide area transceiver 168 is a cellular telephone transceiver. In some cases, the location data is time stamped. In contrast, where user attached monitor device 110 is within range of a public WiFi access point, reporting the location of user attached monitor device 110 may be done via the public WiFi access point in place of the cellular communication link.

Which technologies (e.g., GNSS and/or WiFi) are used to update the location of user attached monitor device 110 may be selected either by default, by programming from central monitor station 160, or based upon conditions detected in user attached monitor device 110 with corresponding pre-determined selections. For example, it may be determined whether sufficient battery power as reported by power status 196 remains in user attached monitor device 110 to support a particular position determination technology. Where insufficient power remains, using the proxy location by communicating the identification information of user attached monitor device 110 to a non-associated device 172 may be enabled and other location technologies disabled.

In some cases, a maximum cost of resolving location may be set for user attached monitor device 110. For example, resolving WiFi location data or via a non-associated device may incur a per transaction cost to have a third-party service provider resolve the location information. When a maximum number of resolution requests have been issued, the WiFi position determination technology or the non-associated device approach may be disabled.

Further, it may be determined whether the likelihood that a particular position determination technology will be capable of providing meaningful location information. For example, where user attached monitor device 110 is moved indoors, GPS receiver 162 may be disabled to save power. Alternatively, where the tracking device is traveling at relatively high speeds, WiFi receiver 188 may be disabled. As yet another example, where cellular phone jamming is occurring, support for cell tower triangulation position determination may be disabled. As yet another example, where GPS jamming is occurring, GPS receiver 162 may be disabled. As yet another example, where user attached monitor device 110 is stationary, the lowest cost (from both a monetary and power standpoint) tracking may be enabled while all other technologies are disabled. Which position determination technologies are used may be based upon a zone in which a tracking device is located. Some zones may be rich in WiFi access points and in such zones WiFi technology may be used. Otherwise, another technology such as cell tower triangulation or GPS may be used. Based upon the disclosure provided herein, one of ordinary skill in the art will recognize other scenarios and corresponding combinations of technologies may be best.

Controller circuit 167 of user attached monitor device 110 at times functions in conjunction with wide area transceiver 168 to send and receive data and signals through wide area communication network 150. This link at times is useful for passing information and/or control signals between a central monitoring system 160 and user attached monitor device 110. The information transmitted may include, but is not limited to, location information, measured alcohol information, one or more passive or active impairment tests applied to the monitored individual, and information about the status of user attached monitor device 110. Based on the disclosure provided herein, one of ordinary skill in the art will recognize a variety of information that may be transferred via wide area communication network 150.

Various embodiments of user attached monitor device 110 include a variety of sensors capable of determining the status of user attached monitor device 110, and of the individual to which it is attached. For example, a status monitor 166 may include one or more of the following subcomponents: power status sensor 196 capable of indicating a power status of user attached monitor device 110, and/or a pulse/ECG sensor 1001 operable to sense pulse rate of the monitored individual and an electrocardiogram unique to the monitored individual based upon electrodes (not shown) in contact with the skin of the monitored individual. The power status may be expressed, for example as a percentage of battery life remaining. Based upon the disclosure provided herein, one of ordinary skill in the art will recognize a variety of forms in which power status may be expressed. The pulse rate may be expressed in beats per minute and the ECG may be shown visually via display 159. Based upon the disclosure provided herein, one of ordinary skill in the art will recognize a variety of forms in which pulse rate and/or ECG rate may be expressed.

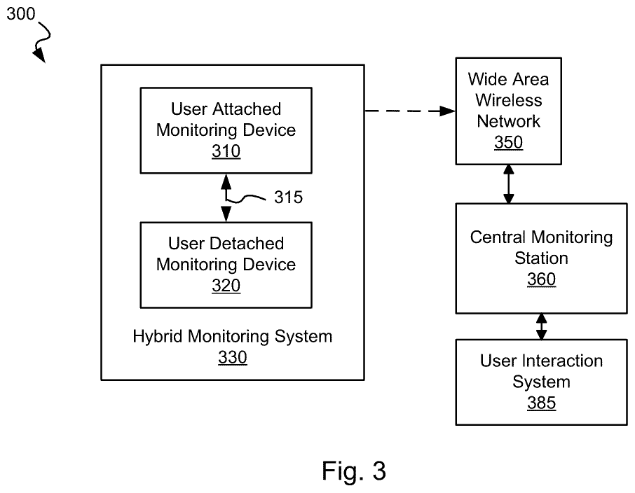

In addition, user attached monitor device 110 includes a set of shielding sensors 169 that are capable of determining whether user attached monitor device 110 is being shielded from receiving GPS signals and/or if GPS jamming is ongoing, a set of device health indicators 154, a tamper sensor 151 capable of determining whether unauthorized access to user attached monitor device 110 has occurred or whether user attached monitor device 110 has been removed from an associated individual being monitored, and/or a motion/proximity sensor 152 capable of determining whether user attached monitor device 110 is moving and/or whether it is within proximity of an individual associated with user detached monitor device (not shown-see FIG. 3) associated with the monitored individual. In some cases, motion/proximity sensor 152 includes one or more accelerometer sensors and/or vibration gyro sensors that are capable of sensing motion of the monitored individual. In addition, motion/proximity sensor 152 includes sensors capable of determining a proximity of user attached monitor device 110 to a monitored individual to which the device is assigned. This information may be used to assure that the monitored individual is wearing user attached monitor device 110. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into user attached monitor device 110 according to various different instances and/or embodiments.

In some embodiments, a user input (not shown) may be integrated into a display 159 and allows for a user of user attached monitor device 110 to provide information to user attached monitor device 110. Display 159 is communicatively coupled to controller circuit 167.

In various instances, user attached monitor device 110 may be operated independently in reporting its location. In such an embodiment, movement information from motion/proximity sensor 152 is provided to controller circuit 167. Such movement information may be any type of movement information known in the art including, but not limited to, movement information from an accelerometer sensor, and/or from vibration gyro sensors. This movement information is used by controller circuit 167 executing a software or firmware application to determine a magnitude and/or direction of movement of user attached monitor device 110 over a period of time. This period of time may be a moving window of time where the amount of time is user programmable. In particular embodiments, the period of time is five (5) minutes.

The movement information is used to estimate movement over a preceding period of time to yield a movement estimate. In some embodiments, this estimate is made by controller circuit 167 from which the movement information was received and is done by executing a software application executing on the controller to yield the estimate of movement. In particular embodiments, the preceding time period is five (5) minutes. Controller circuit 167 determines whether the estimated distance is less than a threshold. In some embodiments, the threshold is a user programmable value. In particular embodiment, the threshold is less than fifty (50) feet. In particular embodiments, the threshold is twenty (20) feet. Based upon the disclosure provided herein, one of ordinary skill in the art will recognize a variety of threshold values that may be used in relation to different embodiments.

Where the estimated distance is less than the threshold, controller circuit 167 updates a movement register in memory 165 to indicate insignificant movement. Alternatively, where the estimated distance is not less than the threshold, controller circuit 167 updates the register in memory 165 to indicate movement. In this way, other operations may access the most current movement status by accessing the register in memory 165. The process of updating the movement status of the monitor device may be continuously performed.

Where an indication of insignificant movement is stored to the register in memory 165, controller circuit 167 turns off the location determination circuit of user attached monitor device 110 (e.g., GPS receiver 162, and/or location processes associated with WIFi Receiver 188). In various embodiments, turning off the location determination circuit includes removing all power from the circuitry. In other embodiments, turning off the location determination circuit includes removing all power from the circuitry includes transitioning the location determination circuit to a sleep state. Based upon the disclosure provided herein, one of ordinary skill in the art will recognize a variety of approaches for reducing power consumption by the location determination circuit that may be used in relation to different embodiments.

Alternatively, where user attached monitor device 110 has registered an indication of movement (i.e., not insignificant movement), controller circuit 167 ensures that the location determination circuit of user attached monitor device is turned on (i.e., enabled to update the location of user attached monitor device). Location information is received by controller circuit 167 from the location determination circuit of user attached monitor device 110. This location information may be that available from a GPS or GNSS location system or from any other type of location determination circuit known in the art. This location is stored in memory 165 as the most recently received location. In some embodiments, a number of locations are recorded in a rotating register with a pointer pointing to the most recently received. Based upon the disclosure provided herein, one of ordinary skill in the art will recognize a variety of memory structures that may be implemented in the memory of the monitor device.

Controller circuit 167 determines whether it is time to report the location of user attached monitor device 110. In some embodiments, location is periodically reported. In some cases, the period is user programmable and is indicated by a timer in controller circuit 167. In various cases, the period if five (5) minutes. Based upon the disclosure provided herein, one of ordinary skill in the art will recognize a variety of time periods that may be used in relation to different embodiments. Where it is time to report the location, controller circuit 167 retrieves the most recent location from memory 165 and communicates it to central monitor station 160 using wide area transceiver 168. Of note, where the location determination circuit is turned off due to insignificant movement of the monitor device, the location reported will be the last location updated by the location determination circuit before it was turned off.

In some instances, user attached monitor device 110 may be operated as part of a hybrid monitoring system similar to that discussed below in relation to FIG. 3. In such instances, movement information from motion/proximity sensor 152 is provided to controller circuit 167. Such movement information may be any type of movement information known in the art including, but not limited to, movement information from an accelerometer sensor, and/or from vibration gyro sensors. This movement information is used by controller circuit 167 executing a software or firmware application to determine a magnitude and/or direction of movement of user attached monitor device 110.

The movement information is used to estimate movement over a preceding time period to yield a movement estimate. In some embodiments, this estimate is made by controller circuit 167 from which the movement information was received and is done by executing a software application executing on the controller to yield the estimate of movement. In some embodiments, the preceding time period is a user programmable value. In particular embodiments, the preceding time period is five (5) minutes. Controller circuit 167 determines whether the estimated distance is less than a threshold. In some embodiments, the threshold is a user programmable value. In various embodiments, the threshold is less than fifty (50) feet. In particular embodiments, the threshold is twenty (20) feet. Based upon the disclosure provided herein, one of ordinary skill in the art will recognize a variety of threshold values that may be used in relation to different embodiments. This movement information indicating movement or lack thereof of user attached monitor device is reported to user detached monitor device 210 where it is used to control updating and reporting of location information.

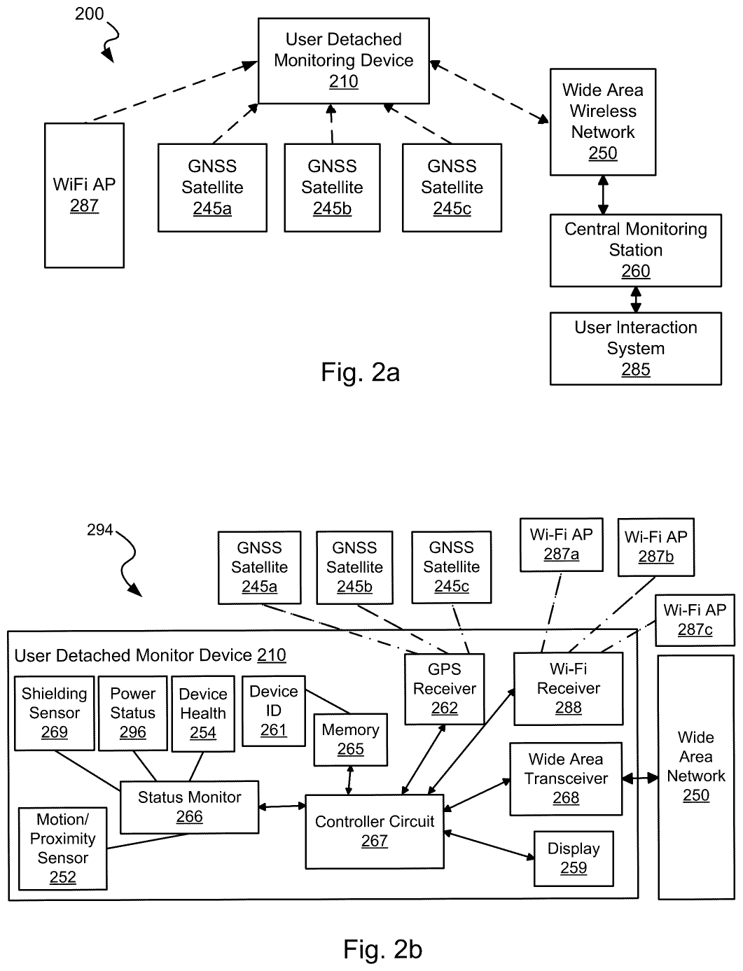

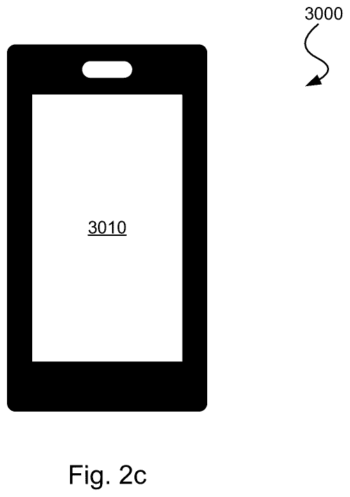

In various instances where user attached monitor device 110 is operated as part of a hybrid monitoring system similar to that discussed below in relation to FIG. 3, it may receive change of movement status information from user detached monitor device 210. This change of movement status information may be, but is not limited to, movement information which was generated by user detached monitor device 210 based upon a motion/proximity sensor 252 (as more fully discussed below in relation to FIGS. 2a-2c). Where a change in movement status is received by user attached monitor device 110, the received movement status is updated by user attached monitor device 110. This may include, for example, writing the new movement status to a register in memory 165 of user attached monitor device.

Controller circuit 167 accesses the register in memory 165 to determine movement status and where the movement status indicates insignificant movement, controller circuit 167 turns off the location determination circuit of user attached monitor device 110. Turning off the location determination circuit includes any reduction in power consumption of the location determination circuit. In various embodiments, turning off the location determination circuit includes removing all power from the circuitry. In other embodiments, turning off the location determination circuit includes removing all power from the circuitry includes transitioning the location determination circuit to a sleep state. Based upon the disclosure provided herein, one of ordinary skill in the art will recognize a variety of approaches for reducing power consumption by the location determination circuit that may be used in relation to different embodiments.

Alternatively, where the movement status indicates more than insignificant movement, controller circuit 167 ensures that the location determination circuit is turned on (i.e., enabled to update the location of the monitor device). Controller circuit 167 receives location information from the location determination circuit (e.g., one or both of GPS receiver 162 and/or location functionality of WiFi receiver 188). In some embodiments, controller circuit 167 records a number of locations in a rotating register in memory 165 with a pointer pointing to the most recently received. Based upon the disclosure provided herein, one of ordinary skill in the art will recognize a variety of memory structures that may be implemented in the memory of the monitor device.

Controller 167 determines whether it is time to report the location of the monitor device. In some embodiments, location is periodically reported. In some cases, the period is user programmable and is indicated by a timer in a controller of the monitor device. In various cases, the period is five (5) minutes. Based upon the disclosure provided herein, one of ordinary skill in the art will recognize a variety of time periods that may be used in relation to different embodiments. Where it is time to report the location, controller circuit 167 transmits the most recently received location to central monitoring station 160 using wide area transceiver 168. Of note, where the location determination circuit is turned off due to insignificant movement of the monitor device, the location reported will be the last location updated by the location determination circuit before it was turned off.

Turning to FIG. 1c, a user attached monitor device 2065 is shown with an example attachment element 2090 connected at opposite ends of user attached monitor device 2065 (i.e., a first end 2096 and a second end 2098). User attached monitor device 2065 is one example implementation of user attached monitor device 110 of FIGS. 1a-1b or user attached monitor device 310 of FIG. 3. Attachment element 2090 has an outer surface 2092 and an inner surface 2091. Attachment element 2090 is operable to securely attach a user attached monitor device 2065 to a limb of an individual in accordance with some embodiments. In some cases, attachment element 2090 is tailored to attach to a wrist of a monitored individual. In various embodiments, attachment element 2090 includes electrically and/or optically conductive material used to make a conductive connection from first end 2096 to second end 2098 through attachment element 2090 and is used in relation to determining whether user attached monitor device 2065 remains attached and/or has been tampered with. Thus, for example, where attachment element 2090 is cut, the conductive connection is broken indicating a tamper has occurred. While FIG. 1c shows a strap as an example attachment element, based upon the disclosure provided herein, one of ordinary skill in the art will recognize other types of attachment elements that may be used in relation to different embodiments. In other embodiments, attachment element 2090 is long enough to attach around the torso of the monitored individual and is sufficiently flexible to allow expansion and contraction of the chest of the monitored individual as they breathe. Such expansion and contraction may be used to sense respiration rate of the monitored individual.

User attached monitor device 2065 includes a case 2089 in which various electronic components are maintained. In addition, user attached monitor device 2065 includes a button 2083, a radial dial 2085, a display 2087 (which may be a touchscreen display), and a combination speaker, microphone, and image sensor 2079. Together, user attached monitor device 2065 includes a button 2083, a radial dial 2085, a display 2087, a combination speaker, microphone, and image sensor 2079 provide the user interface for user attached monitor device 2065 and support the functionality of the various sensors discussed above in relation to FIG. 1b. Based upon the disclosure provided herein, one of ordinary skill in the art will recognize a variety of inputs and outputs that may be incorporated into user attached monitor device 2065 to provide the functionality discussed herein.

Turning to FIG. 1d, a user attached monitor device 1100 is shown with an example attachment element 1090 connected at opposite ends of a case 1089. User attached monitor device 1100 is another example implementation of user attached monitor device 110 of FIGS. 1a-1b or user attached monitor device 310 of FIG. 3. Attachment element 1090 is configured to securely attach a case 1089 to a limb of an individual in accordance with some embodiments. In various embodiments, attachment element 1090 includes electrically and/or optically conductive material used to make a conductive connection from one side of case 1089 to the opposite side of case 1089 and is used in relation to determining whether user attached monitor device 1100 remains attached and/or has been tampered with. While FIG. 1d shows a strap as an example attachment element, based upon the disclosure provided herein, one of ordinary skill in the art will recognize other types of attachment elements that may be used in relation to different embodiments.

Turning to FIG. 2a, a block diagram of a location monitoring system 200 that includes a user detached monitor device 210 in accordance with some embodiments. As shown, location monitoring system 200 includes user detached monitor device 210 that is communicably coupled to a central monitoring station 260 via a wide area wireless network 250 (e.g., cellular telephone network, Internet via a WiFi access point, or the like).

Central monitoring station 260 may be any location, device or system where location data and/or other types of data are received, including by way of non-limiting example: a cellular/smart phone, an email account, a website, a network database, and a memory device. The location data and/or other types of data are stored by central monitoring station 260 and is retrievable by a monitoring individual, such as a parent, guardian, parole officer, court liaison, spouse, friend, or other authorized group or individual. In this manner, the monitoring individual is able to respond appropriately to detected activity of a monitored individual. In some cases, the monitoring individual is able to retrieve the location data and/or other data types via a user interaction system 285 which may be, but is not limited to, a network connected user interface device communicatively coupled via a network to central monitoring station 260 and/or directly to user attached monitor device 210 via wide area wireless network 250.

Central monitoring station 260 may include a server supported website, which may be supported by a server system comprising one or more physical servers, each having a processor, a memory, an operating system, input/output interfaces, and network interfaces, all known in the art, coupled to the network. The server supported website comprises one or more interactive web portals through which the monitor may monitor the location of the monitored individual in accordance with the described embodiments. In particular, the interactive web portals may enable the monitor to retrieve the location and user identification data of one or more monitored individuals, set or modify ‘check-in’ schedules, and/or set or modify preferences. The interactive web portals are accessible via a personal computing device, such as for example, a home computer, laptop, tablet, and/or smart phone.

In some embodiments, the server supported website comprises a mobile website or mobile application accessible via a software application on a mobile device (e.g. smart phone). The mobile website may be a modified version of the server supported website with limited or additional capabilities suited for mobile location monitoring.

Turning to FIG. 2b, a block diagram 294 of user detached monitor device 210 is shown in accordance with some embodiments. As shown, user detached monitor device 210 includes a device ID 261 that may be maintained in a memory 265, and is thus accessible by a controller circuit 267. Controller circuit 267 interacts with a GPS receiver 262 (one of many examples of location determination circuit) and memory 265 at times for storing and generating records of successively determined GPS locations. Similarly, controller circuit 267 interacts with a WiFi receiver 288 and memory 265 at times for storing and generating records of successively determined WiFi access point identifications and signal strength. In some cases, memory 265 may include instructions (e.g., software-based or firmware-based instructions) executable by controller circuit 267 to perform and/or enable various functions associated with user attached monitor device 210. As user detached monitor device 210 comes within range of one or more WiFi access points (e.g., a WiFi access point 287a, a WiFi access point 287b, and/or a WiFi access point 287c), WiFi receiver 288 senses the signal provided by the respective WiFi access points, and provides an identification of the respective WiFi access point and a signal strength of the signal received from the WiFi access point to WiFi receiver 288. The combination of controller circuit 267 and WiFi receiver 288 is one of many examples of location determination circuit. This information is provided to controller circuit 267 which stores the information to memory 265.

In operation, controller circuit 267 causes an update and reporting of the location of user detached monitor device 210 via a wide area transceiver 268 and wide area communication network 250. In some embodiments, wide area transceiver 268 is a cellular telephone transceiver. In some cases, the location data is time stamped. In contrast, where user detached monitor device 210 is within range of a public WiFi access point, reporting the location of user detached monitor device 210 may be done via the public WiFi access point in place of the cellular communication link.

Which technologies (e.g., GNSS and/or WiFi) are used to update the location of user detached monitor device 210 may be selected either by default, by programming from central monitor station 260, or based upon conditions detected in user detached monitor device 210 with corresponding pre-determined selections. For example, it may be determined whether sufficient battery power as reported by power status 296 remains in user detached monitor device 210 to support a particular position determination technology. Where insufficient power remains, using the proxy location by communicating the identification information of user detached monitor device 210 to a non-associated device 272 may be enabled and other location technologies disabled.

In some cases, a maximum cost of resolving location may be set for user attached monitor device 210. For example, resolving WiFi location data or via a non-associated device may incur a per transaction cost to have a third-party service provider resolve the location information. When a maximum number of resolution requests have been issued, the WiFi position determination technology or the non-associated device approach may be disabled.

Further, it may be determined whether the likelihood that a particular position determination technology will be capable of providing meaningful location information. For example, where user detached monitor device 210 is moved indoors, GPS receiver 262 may be disabled to save power. Alternatively, where the tracking device is traveling at relatively high speeds, WiFi receiver 288 may be disabled. As yet another example, where cellular phone jamming is occurring, support for cell tower triangulation position determination may be disabled. As yet another example, where GPS jamming is occurring, GPS receiver 262 may be disabled. As yet another example, where user detached monitor device 210 is stationary, the lowest cost (from both a monetary and power standpoint) tracking may be enabled while all other technologies are disabled. Which position determination technologies are used may be based upon a zone in which a tracking device is located. Some zones may be rich in WiFi access points and in such zones WiFi technology may be used. Otherwise, another technology such as cell tower triangulation or GPS may be used. Based upon the disclosure provided herein, one of ordinary skill in the art will recognize other scenarios and corresponding combinations of technologies may be best.

Controller circuit 267 of user detached monitor device 210 at times functions in conjunction with wide area transceiver 268 to send and receive data and signals through wide area communication network 250. This link at times is useful for passing information and/or control signals between a central monitoring system 260 and user attached monitor device 210. The information transmitted may include, but is not limited to, location information, measured alcohol information, one or more passive or active impairment tests applied to the monitored individual, and information about the status of user attached monitor device 210. Based on the disclosure provided herein, one of ordinary skill in the art will recognize a variety of information that may be transferred via wide area communication network 250.

Various embodiments of user detached monitor device 210 include a variety of sensors capable of determining the status of user attached monitor device 210, and of the individual to which it is attached. For example, a status monitor 266 may include one or more of the following subcomponents: power status sensor 296 capable of indicating a power status of user attached monitor device 210, and/or a pulse/ECG sensor 2001 operable to sense pulse rate of the monitored individual and an electrocardiogram unique to the monitored individual based upon electrodes (not shown) in contact with the skin of the monitored individual. The power status may be expressed, for example as a percentage of battery life remaining. Based upon the disclosure provided herein, one of ordinary skill in the art will recognize a variety of forms in which power status may be expressed. The pulse rate may be expressed in beats per minute and the ECG may be shown visually via display 259. Based upon the disclosure provided herein, one of ordinary skill in the art will recognize a variety of forms in which pulse rate and/or ECG rate may be expressed.

In addition, user detached monitor device 210 includes a set of shielding sensors 269 that are capable of determining whether user detached monitor device 210 is being shielded from receiving GPS signals and/or if GPS jamming is ongoing, a set of device health indicators 254, a tamper sensor 251 capable of determining whether unauthorized access to user detached monitor device 210 has occurred or whether user detached monitor device 210 has been removed from an associated individual being monitored, and/or a motion/proximity sensor 252 capable of determining whether user detached monitor device 210 is moving and/or whether it is within proximity of an individual associated with user detached monitor device (not shown-see FIG. 3) associated with the monitored individual. In some cases, motion/proximity sensor 252 includes one or more accelerometer sensors and/or vibration gyro sensors that are capable of accurately sensing motion of the monitored individual. In addition, motion/proximity sensor 252 includes sensors capable of determining a proximity of user detached monitor device 210 to a monitored individual to which the device is assigned. This information may be used to assure that the monitored individual is wearing user attached monitor device 210. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into user detached monitor device 210 according to various different instances and/or embodiments.

In some embodiments, a user input (not shown) may be integrated into a display 259 and allows for a user of user detached monitor device 210 to provide information to user attached monitor device 210. Display 259 is communicatively coupled to controller circuit 267.

In various instances, user attached monitor device 210 may be operated independently in reporting its location. In such an embodiment, movement information from motion/proximity sensor 252 is provided to controller circuit 267. Such movement information may be any type of movement information known in the art including, but not limited to, movement information from an accelerometer sensor, and/or from vibration gyro sensors. This movement information is used by controller 267 executing a software or firmware application to determine a magnitude and/or direction of movement of user attached monitor device 210.

The movement information is used to estimate movement over a preceding time period to yield a movement estimate. In some embodiments, this estimate is made by controller 267 from which the movement information was received and is done by executing a software application executing on the controller to yield the estimate of movement. In some embodiments, the preceding time period is a user programmable value. In particular embodiments, the preceding time period is five (5) minutes. Controller 267 determines whether the estimated distance is less than a threshold. In some embodiments, the threshold is a user programmable value. In particular embodiment, the threshold is less than fifty (50) feet. In particular embodiments, the threshold is twenty (20) feet. Based upon the disclosure provided herein, one of ordinary skill in the art will recognize a variety of threshold values that may be used in relation to different embodiments.

Where the estimated distance is less than the threshold, controller 267 updates a movement register in memory 265 to indicate insignificant movement. Alternatively, where the estimated distance is not less than the threshold, controller circuit 267 updates the register in memory 265 to indicate movement. In this way, other operations may access the most current movement status by accessing the register in memory 265. The process of updating the movement status of the monitor device may be continuously performed.

Where an indication of insignificant movement is stored to the register in memory 265, controller 267 turns off the location determination circuit of user attached monitor device 210 (e.g., GPS receiver 262, and/or location processes associated with WIFi Receiver 288). In various embodiments, turning off the location determination circuit includes removing all power from the circuitry. In other embodiments, turning off the location determination circuit includes removing all power from the circuitry includes transitioning the location determination circuit to a sleep state. Based upon the disclosure provided herein, one of ordinary skill in the art will recognize a variety of approaches for reducing power consumption by the location determination circuit that may be used in relation to different embodiments.

Alternatively, where user attached monitor device 210 has registered an indication of movement (i.e., not insignificant movement), controller 267 ensures that the location determination circuit of user attached monitor device is turned on (i.e., enabled to update the location of the monitor device. Location information is received by controller circuit 267 from the location determination circuit of user attached monitor device 210. This location information may be that available from a GPS or GNSS location system or from any other type of location determination circuit known in the art. This location is stored in memory 265 as the most recently received location. In some embodiments, a number of locations are recorded in a rotating register with a pointer pointing to the most recently received. Based upon the disclosure provided herein, one of ordinary skill in the art will recognize a variety of memory structures that may be implemented in the memory of the monitor device.

Controller 267 determines whether it is time to report the location of user attached monitor device 267. In some embodiments, location is periodically reported. In some cases, the period is user programmable and is indicated by a timer in controller 267. In various cases, the period is five (5) minutes. Based upon the disclosure provided herein, one of ordinary skill in the art will recognize a variety of time periods that may be used in relation to different embodiments. Where it is time to report the location, controller 267 retrieves the most recent location from memory 265 and communicates it to central monitor station 260 using wide area transceiver 268. Of note, where the location determination circuit is turned off due to insignificant movement of the monitor device, the location reported will be the last location updated by the location determination circuit before it was turned off.

In some instances, user attached monitor device 210 may be operated as part of a hybrid monitoring system similar to that discussed below in relation to FIG. 3. In such an embodiment, movement information from motion/proximity sensor 252 is provided to controller circuit 267. Such movement information may be any type of movement information known in the art including, but not limited to, movement information from an accelerometer sensor, and/or from vibration gyro sensors. This movement information is used by controller 267 executing a software or firmware application to determine a magnitude and/or direction of movement of user attached monitor device 210.

The movement information is used to estimate movement over a preceding time period to yield a movement estimate. In some embodiments, this estimate is made by controller 267 from which the movement information was received and is done by executing a software application executing on the controller to yield the estimate of movement. In some embodiments, the preceding time period is a user programmable value. In particular embodiments, the preceding time period is five (5) minutes. Controller 267 determines whether the estimated distance is less than a threshold. In some embodiments, the threshold is a user programmable value. In particular embodiment, the threshold is less than fifty (50) feet. In particular embodiments, the threshold is twenty (20) feet. Based upon the disclosure provided herein, one of ordinary skill in the art will recognize a variety of threshold values that may be used in relation to different embodiments. This movement information indicating movement or lack thereof of user attached monitor device is reported to user detached monitor device 210 where it is used to control updating and reporting of location information.

In various instances where user detached monitor device 210 is operated as part of a hybrid monitoring system similar to that discussed below in relation to FIG. 3, it may receive change of movement status information from user attached monitor device 110. This change of movement status information may be, but is not limited to, movement information which was generated by user attached monitor device 110 based upon a motion/proximity sensor 152 (as more fully discussed below in relation to FIGS. 1a-1d). Where a change in movement status is received by user detached monitor device 210, the received movement status is updated by user detached monitor device 210. This may include, for example, writing the new movement status to a register in memory 265 of user attached monitor device.

Controller circuit 267 accesses the register in memory 265 to determine movement status and where the movement status indicates insignificant movement, controller circuit 267 turns off the location determination circuit of user detached monitor device 210. Turning off the location determination circuit includes any reduction in power consumption of the location determination circuit. In various embodiments, turning off the location determination circuit includes removing all power from the circuitry. In other embodiments, turning off the location determination circuit includes removing all power from the circuitry includes transitioning the location determination circuit to a sleep state. Based upon the disclosure provided herein, one of ordinary skill in the art will recognize a variety of approaches for reducing power consumption by the location determination circuit that may be used in relation to different embodiments.

Alternatively, where the movement status indicates more than insignificant movement, controller circuit 267 ensures that the location determination circuit is turned on (i.e., enabled to update the location of the monitor device). Controller circuit 267 receives location information from the location determination circuit (e.g., one or both of GPS receiver 262 and/or location functionality of WiFi receiver 288). In some embodiments, controller circuit 267 records a number of locations in a rotating register in memory 265 with a pointer pointing to the most recently received. Based upon the disclosure provided herein, one of ordinary skill in the art will recognize a variety of memory structures that may be implemented in the memory of the monitor device.

Controller 267 determines whether it is time to report the location of the monitor device. In some embodiments, location is periodically reported. In some cases, the period is user programmable and is indicated by a timer in a controller of the monitor device. In various cases, the period is five (5) minutes. Based upon the disclosure provided herein, one of ordinary skill in the art will recognize a variety of time periods that may be used in relation to different embodiments. Where it is time to report the location, controller circuit 267 transmits the most recently received location to central monitoring station 260 using wide area transceiver 268. Of note, where the location determination circuit is turned off due to insignificant movement of the monitor device, the location reported will be the last location updated by the location determination circuit before it was turned off.

Turning to FIG. 2c, an example user detached monitor device 3000 is shown. User detached monitor device 3000 is one example implementation of user detached monitor device 210 of FIGS. 2a-2b or user attached monitor device 320 of FIG. 3. User detached monitor device 3000 may be a cellular telephone with a touch screen display 3010. Based upon the disclosure provided herein, one of ordinary skill in the art will recognize a variety of device types that may be used as user detached monitor devices in accordance with different embodiments including, but not limited to, tablet devices.

Turning to FIG. 3, a location monitoring system 300 is shown in accordance with various embodiments that includes a hybrid monitoring system 330 in accordance with various embodiments. Hybrid monitoring system 330 includes a user detached monitor device 320, a user attached monitor device 310, and location information replacement functionality included in one or both of user detached monitor device 320 and/or user attached monitor device 310. Hybrid monitoring system User attached monitor device 310 is similar to either user attached monitor device 110 or user detached monitor device 210.

User detached monitor device 320 is portable and may be any device that is recognized as being used by or assigned to an individual being monitored, but is not physically attached to the individual being monitored by a tamper evident attaching device. User detached monitor device 320 may be, but is not limited to, a cellular or mobile telephone configured to communicate with user attached monitor device 310 via a local communication link 315. In contrast, user attached monitor device 310 is attached to the individual being monitored using a tamper evident attaching device like a strap. User attached monitor device 310 may be, but is not limited to, a tracking device that is attached around the limb of an individual and includes indicators to monitor whether the device has been removed from the individual or otherwise tampered.

Location monitoring system 300 further includes a central monitoring station 360 wirelessly coupled to user attached monitor device 310 and/or user detached monitor device 320 via one or more wide area wireless (e.g., cellular telephone network, Internet via a Wi-Fi access point, or the like) communication networks 350.

User detached monitor device 320 includes a location sensor or location determination circuit that senses the location of the device and generates a location data. The location data may comprise one or more of: global positioning system (“GPS”) data, Assisted GPS (“A-GPS”) data, Advanced Forward Link Trilateration (“AFLT”) data, and/or cell tower triangulation data. The aforementioned location data is utilized verify the location of a user associated with user detached monitor device 320 at various points as more fully discussed below. User detached monitor device 320 is considered “ambiguous” because it is not attached to the user in a tamper resistant/evident way, but rather is freely severable from the user and thus could be used by persons other than the target. Various processes discussed herein mitigate the aforementioned ambiguity to yield a reasonable belief that information derived from user detached monitor device 320 corresponds to the target.

The location data and/or other data gathered by user detached monitor device 320 may be wirelessly transmitted to central monitoring station 360 via wide area wireless network. Central monitoring station 360 may be any location, device or system where the location data is received, including by way of non-limiting example: a cellular/smart phone, an email account, a website, a network database, and a memory device. The location data is stored by central monitoring station 360 and is retrievable therefrom by a monitor, such as a parent, guardian, parole officer, court liaison, spouse, friend, or other authorized group or individual. In this manner, monitor is able to respond appropriately to the detected out-of-bounds activity by a user. In some cases, the monitor is able to retrieve the location data via a user interaction system 385 which may be, but is not limited to, a network connected user interface device communicatively coupled via a network to central monitoring station 360 and/or directly to user detached monitor device 320 via wide area wireless network 350.

User detached monitor device 320 may further include a user identification sensor operable to generate user identification data for identifying the user in association with the generation of the location data. The user identification data may comprise one or more of: image data, video data, biometric data (e.g. fingerprint, DNA, retinal scan, etc. data), or any other type of data that may be used to verify the identity of the user at or near the time the location data is generated. And the user identification sensor may comprise one or more of: a camera, microphone, heat sensor, biometric data sensor, or any other type of device capable of sensing/generating the aforementioned types of user identification data.

The user identification data is wirelessly transmitted in association with the location data to central monitoring station 360 via a wireless transmitter communicatively coupled to the user identification sensor. The user identification data is stored in association with the location data by central monitoring station 360 and is retrievable therefrom by a monitor, such as a parent, guardian, parole officer, court liaison, spouse, friend, or other authorized group or individual. The monitor is configured to retrieve the location data via a network connected user interface device communicatively coupled-via the network—to central monitoring station 360 and/or to user detached monitor device 320. The location data may be transmitted to central monitoring station 360 independent of the user identification data, for example, during a periodic check-in with central monitoring system 360.

User detached monitor device 320 may further comprise a memory communicatively coupled to a control unit-which is also communicatively coupled to the location sensor, the identification sensor and the wireless transceiver—for controlling the operations thereof in accordance with the functionalities described herein. The memory may include instructions (e.g., software of firmware based instructions) executable by the control unit to perform and/or enable various functions associated with user detached monitor device 320. As user detached monitor device 320 is portable, each of the components may be located within, immediately adjacent to, or exposed without, a device housing whose dimensions are such that user detached monitor device 320 as a whole may be discretely carried by the user, for example, within a pocket or small purse.

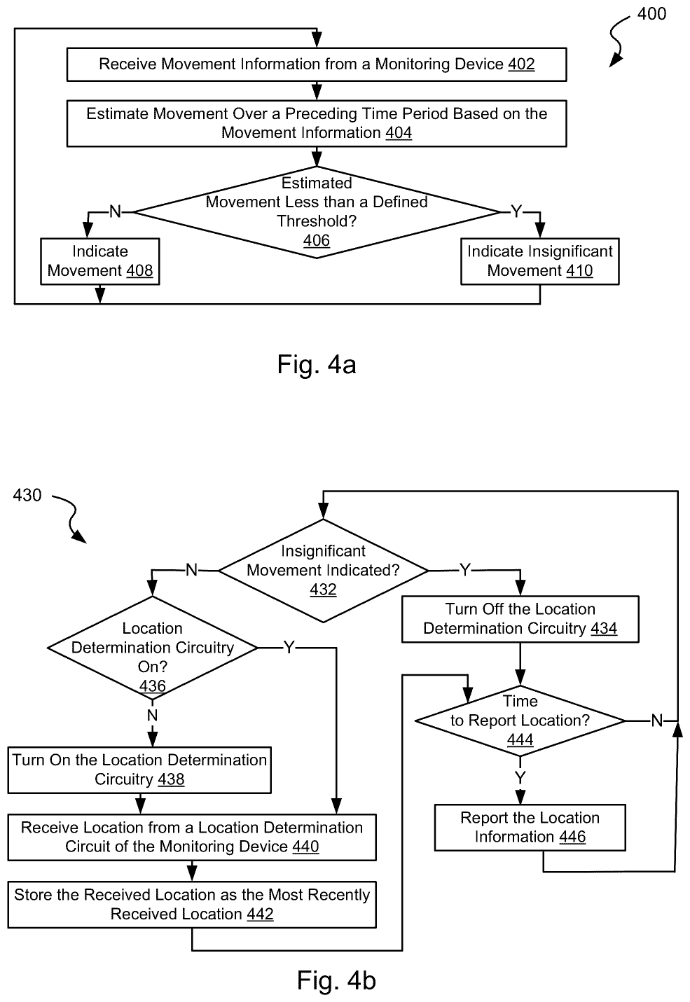

Turning to FIGS. 4a-4b, flow diagrams 400, 430 show a method in accordance with some embodiments for reporting location information in a scenario where a monitoring device indicates it has not moved significantly. Following flow diagram 400 of FIG. 4a, movement information is received from a monitoring device (block 402). In some embodiments, this includes controller circuit 167 receiving movement information from motion/proximity sensor 152 in user attached monitor device 110. In other embodiments, this includes controller circuit 267 receiving movement information from motion/proximity sensor 252 in user detached monitor device 110. Such movement information may be any type of movement information known in the art that may be used by a controller or processor executing a software application to determine a magnitude and/or direction of movement.

The movement information is used to estimate movement over a preceding time period to yield a movement estimate (block 404). In some embodiments, this estimate is made by a controller in the monitoring device from which the movement information was received and is done by executing a software application executing on the controller to yield the estimate of movement. In some embodiments, the preceding time period is a user programmable value. In particular embodiments, the preceding time period is five (5) minutes. It is determined whether the estimated distance is less than a threshold (block 406). In some embodiments, the threshold is a user programmable value. In particular embodiment, the threshold is less than fifty (50) feet. In particular embodiments, the threshold is twenty (20) feet. Based upon the disclosure provided herein, one of ordinary skill in the art will recognize a variety of threshold values that may be used in relation to different embodiments.

Where the estimated distance is less than a threshold (block 406), insignificant movement is indicated (block 410). Such an indication of insignificant movement may be stored in a memory that is overwritten when the status changes due to increased movement. In this way, other operations may access the most current movement status. Alternatively, where the estimated distance is not less than a threshold (block 406), movement is indicated (block 408). Such an indication of movement may be stored to the same memory by overwriting a prior movement status. Again, in this way, other operations may access the most current movement status. This process of updating the movement status of the monitor device may be continuously performed.

Turning to FIG. 4b and following flow diagram 430, where it is determined that the monitor device has registered an indication of insignificant movement (block 432), the location determination circuit of the monitor device is turned off (block 434). In some embodiments, determining that the monitor device has registered an indication of insignificant movement includes reading the memory discussed above in relation to FIG. 4a where the movement status is located. Turning off the location determination circuit includes any reduction in power consumption of the location determination circuit. In various embodiments, turning off the location determination circuit includes removing all power from the circuitry. In other embodiments, turning off the location determination circuit includes removing all power from the circuitry includes transitioning the location determination circuit to a sleep state. Based upon the disclosure provided herein, one of ordinary skill in the art will recognize a variety of approaches for reducing power consumption by the location determination circuit that may be used in relation to different embodiments.

Alternatively, where it is determined that the monitor device has registered an indication of movement (i.e., not insignificant movement) (block 432), it is determined if the location determination circuit is on (i.e., enabled to update the location of the monitor device)(block 436). Where the location determination circuit is not turned on (block 436), it is turned on such that it can update a location of the monitor device (block 438). Location information is received from the location determination circuit of the monitor device (block 440). This location information may be that available from a GPS or GNSS location system or from any other type of location determination circuit known in the art. This location is stored in a memory of the monitor device as the most recently received location (block 442). In some embodiments, a number of locations are recorded in a rotating register with a pointer pointing to the most recently received. Based upon the disclosure provided herein, one of ordinary skill in the art will recognize a variety of memory structures that may be implemented in the memory of the monitor device.

It is determined whether it is time to report the location of the monitor device (block 444). In some embodiments, location is periodically reported. In some cases, the period is user programmable and is indicated by a timer in a controller of the monitor device. In various cases, the period is five (5) minutes. Based upon the disclosure provided herein, one of ordinary skill in the art will recognize a variety of time periods that may be used in relation to different embodiments. Where it is time to report the location (block 444), the most recently received location is reported (block 446). Of note, where the location determination circuit is turned off due to insignificant movement of the monitor device, the location reported will be the last location updated by the location determination circuit before it was turned off.

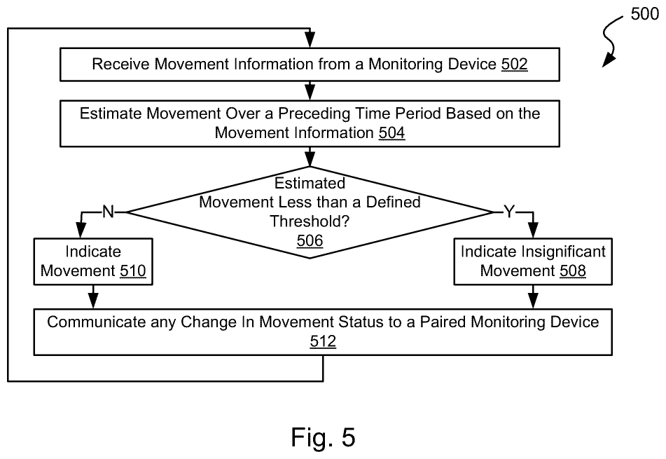

Turning to FIG. 5, a flow diagram 500 shows a method in accordance with some embodiments for determining movement of one monitor device in a hybrid monitoring system, and reporting that movement information to another monitor device in the hybrid monitoring system. Following flow diagram 500, movement information is received from a monitoring device (block 502). In some embodiments, this includes controller circuit 167 receiving movement information from motion/proximity sensor 152 in user attached monitor device 110. In other embodiments, this includes controller circuit 267 receiving movement information from motion/proximity sensor 252 in user detached monitor device 110. Such movement information may be any type of movement information known in the art that may be used by a controller or processor executing a software application to determine a magnitude and/or direction of movement.

The movement information is used to estimate movement over a preceding time period to yield a movement estimate (block 504). In some embodiments, this estimate is made by a controller in the monitoring device from which the movement information was received and is done by executing a software application executing on the controller to yield the estimate of movement. In some embodiments, the preceding time period is a user programmable value. In particular embodiments, the preceding time period is five (5) minutes. It is determined whether the estimated distance is less than a threshold (block 506). In some embodiments, the threshold is a user programmable value. In particular embodiment, the threshold is less than fifty (50) feet. In particular embodiments, the threshold is twenty (20) feet. Based upon the disclosure provided herein, one of ordinary skill in the art will recognize a variety of threshold values that may be used in relation to different embodiments.

Where the estimated distance is less than a threshold (block 506), insignificant movement is indicated (block 510). Such an indication of insignificant movement may be stored in a memory that is overwritten when the status changes due to increased movement. In this way, other operations may access the most current movement status. Alternatively, where the estimated distance is not less than a threshold (block 506), movement is indicated (block 508). Such an indication of movement may be stored to the same memory by overwriting a prior movement status. Again, in this way, other operations may access the most current movement status. This process of updating the movement status of the monitor device may be continuously performed. In either case, the movement information is reported to the other monitor device in the hybrid monitor system (block 512). Thus, for example, where the movement information is being generated in user attached monitor device 110, the movement information is communicated from user attached monitor device 110 to user detached monitor device 210. An another example, where the movement information is being generated in user detached monitor device 210, the movement information is communicated from user detached monitor device 210 to user attached monitor device 110.

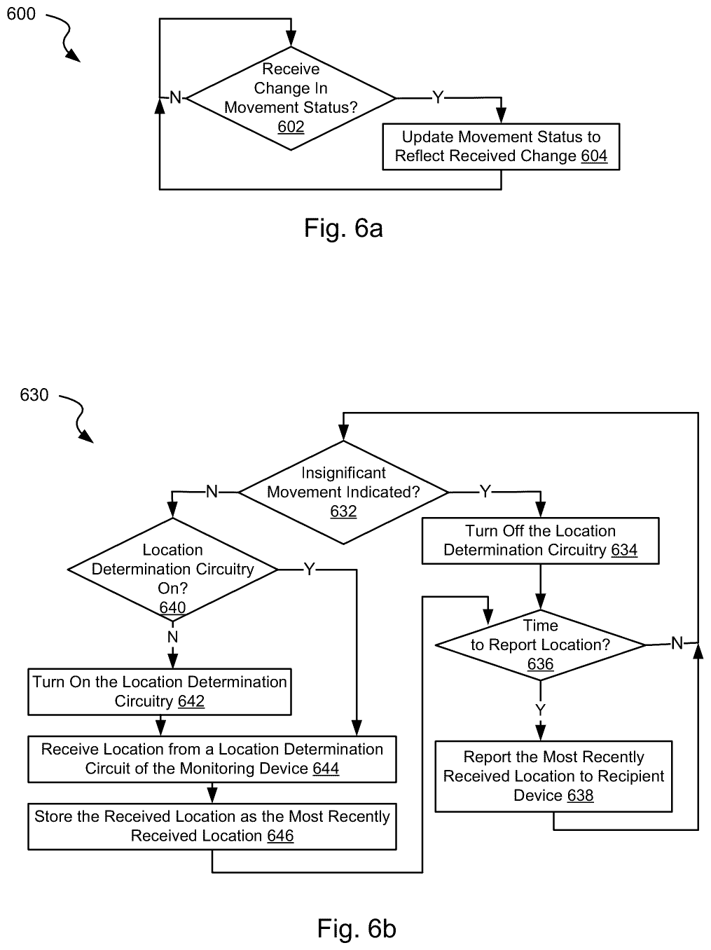

Turning to FIG. 6a, a flow diagram 600 shows a method in accordance with some embodiments for receiving movement status information from another device and updating that information in the receiving monitor device. Following flow diagram 600, it is determined whether a change in movement status has been received from another monitor device in a hybrid monitoring system (block 602). The change of movement status may indicate a change to insignificant movement or the opposite. Thus, as an example, where this method is being performed by user attached monitor device 110, user attached monitor device determines whether a change of movement status was received from user detached monitor device 210. Where a change of movement status is received, the movement status of the receiving monitor device is updated (block 604). This may include, for example, writing the new movement status to a memory of the receiving monitor device.

Turning to FIG. 6b, a flow diagram 630 shows a method in accordance with one or more embodiments for use of movement information from another device to control location updating and reporting in a monitor device. Following flow diagram 630, where it is determined that the monitor device has registered an indication of insignificant movement (block 632), the location determination circuit of the monitor device is turned off (block 634). In some embodiments, determining that the monitor device has registered an indication of insignificant movement includes reading the memory discussed above in relation to FIG. 6a where the movement status is located. Turning off the location determination circuit includes any reduction in power consumption of the location determination circuit. In various embodiments, turning off the location determination circuit includes removing all power from the circuitry. In other embodiments, turning off the location determination circuit includes removing all power from the circuitry includes transitioning the location determination circuit to a sleep state. Based upon the disclosure provided herein, one of ordinary skill in the art will recognize a variety of approaches for reducing power consumption by the location determination circuit that may be used in relation to different embodiments.

Alternatively, where it is determined that the monitor device has registered an indication of movement (i.e., not insignificant movement) (block 632), it is determined if the location determination circuit is on (i.e., enabled to update the location of the monitor device)(block 636). Where the location determination circuit is not turned on (block 636), it is turned on such that it can update a location of the monitor device (block 638). Location information is received from the location determination circuit of the monitor device (block 640). This location information may be that available from a GPS or GNSS location system or from any other type of location determination circuit known in the art. This location is stored in a memory of the monitor device as the most recently received location (block 642). In some embodiments, a number of locations are recorded in a rotating register with a pointer pointing to the most recently received. Based upon the disclosure provided herein, one of ordinary skill in the art will recognize a variety of memory structures that may be implemented in the memory of the monitor device.

It is determined whether it is time to report the location of the monitor device (block 644). In some embodiments, location is periodically reported. In some cases, the period is user programmable and is indicated by a timer in a controller of the monitor device. In various cases, the period is five (5) minutes. Based upon the disclosure provided herein, one of ordinary skill in the art will recognize a variety of time periods that may be used in relation to different embodiments. Where it is time to report the location (block 644), the most recently received location is reported (block 646). Of note, where the location determination circuit is turned off due to insignificant movement of the monitor device, the location reported will be the last location updated by the location determination circuit before it was turned off.

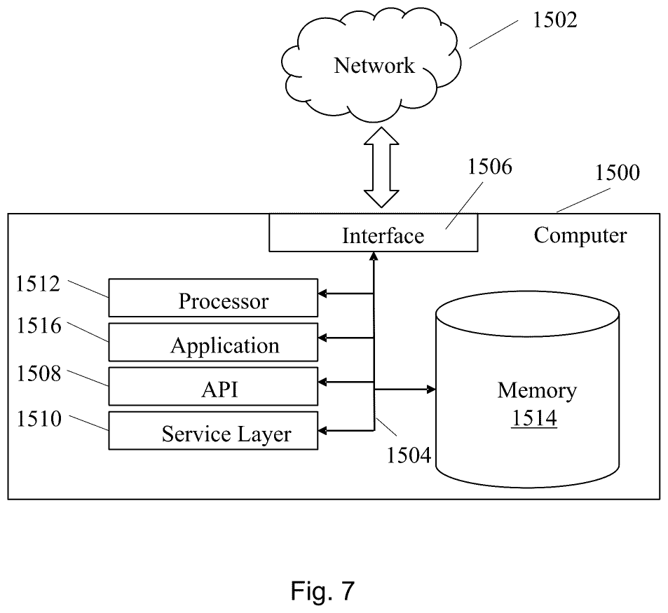

Elements, such as, but not limited to, user detached monitor device 320, user attached monitor device 310, user interaction system 185, central monitoring station 160, user interaction system 285, central monitoring station 260, user interaction system 385, and/or central monitoring station 360 may be implemented on a computer system. FIG. 7 is a block diagram of a computer system 1500 used to provide computational functionalities associated with described algorithms, methods, functions, processes, flows, and procedures as described in the instant disclosure, according to an implementation. Computer system 1500 is one example of a large number of computer systems that may be used to implement different embodiments. Based upon the disclosure provided herein, one of ordinary skill in the art will recognize a wide variety of computer systems that may be used in relation to different embodiments.

Computer system 1500 is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, computer system 1500 may include a computer that includes an input device, such as a keypad, keyboard, touch screen, or other device that can accept user information, and an output device that conveys information associated with the operation of computer system 1500, including digital data, visual, or audio information (or a combination of information), or a GUI.

Computer system 1500 can serve in a role as a client, network component, a server, a database or other persistency, or any other component (or a combination of roles) of a computer system for performing the subject matter described in the instant disclosure. Computer system 1500 is communicably coupled with a network 1502. In some implementations, one or more components of computer system 1500 may be configured to operate within environments, including cloud-computing-based, local, global, or other environment (or a combination of environments).

At a high level, computer system 1500 is an electronic computing device operable to receive, transmit, process, store, or manage data and information associated with the described subject matter. According to some implementations, computer system 1500 may also include or be communicably coupled with an application server, e-mail server, web server, caching server, streaming data server, business intelligence (BI) server, or other server (or a combination of servers).

Computer system 1500 can receive requests over network 1502 from a client application (for example, executing on another computer system (not shown) and responding to the received requests by processing the said requests in an appropriate software application. In addition, requests may also be sent to computer system 1500 from internal users (for example, from a command console or by other appropriate access method), external or third-parties, other automated applications, as well as any other appropriate entities, individuals, systems, or computers.

Each of the components of computer system 1500 can communicate using a system bus 1504. In some implementations, any or all of the components of the computer system 1500, both hardware or software (or a combination of hardware and software), may interface with each other or interface 1506 (or a combination of both) over system bus 1504 using an application programming interface (API) 1508 or a service layer 1510 (or a combination of API 1508 and service layer 1510. API 1508 may include specifications for routines, data structures, and object classes. API 1508 may be either computer-language independent or dependent and refer to a complete interface, a single function, or even a set of APIs. Service layer 1510 provides software services to computer system 1500 or other components (whether or not illustrated) that are communicably coupled to computer system 1500. The functionality of computer system 1500 may be accessible for all service consumers using this service layer. Software services, such as those provided by service layer 1510, provide reusable, defined business functionalities through a defined interface. For example, the interface may be software written in JAVA, C++, or other suitable language providing data in extensible markup language (XML) format or other suitable format. While illustrated as an integrated component of computer system 1500, alternative implementations may illustrate API 1508 or service layer 1510 as stand-alone components in relation to other components of computer system 1500 or other components (whether or not illustrated) that are communicably coupled to computer system 1500. Moreover, any or all parts of API 1508 or service layer 1510 may be implemented as child or sub-modules of another software module, enterprise application, or hardware module without departing from the scope of this disclosure.

Computer system 1500 includes an interface 1506. Although illustrated as a single interface 1506 in FIG. 11, two or more interfaces 1506 may be used according to particular needs, desires, or particular implementations of computer system 1500. Interface 1506 is used by computer system 1500 for communicating with other systems in a distributed environment that are connected to the network 1502. Generally, the interface 1506 includes logic encoded in software or hardware (or a combination of software and hardware) and operable to communicate with the network 1502. More specifically, the interface 1506 may include software supporting one or more communication protocols associated with communications such that the network 1502 or interface's hardware is operable to communicate physical signals within and outside of the illustrated computer system 1500.

Computer system 1500 includes at least one computer processor 1512. Although illustrated as a single computer processor 1512 in FIG. 11, two or more processors may be used according to particular needs, desires, or particular implementations of computer system 1500. Generally, the computer processor 1512 executes instructions and manipulates data to perform the operations of computer system 1500 and any algorithms, methods, functions, processes, flows, and procedures as described in the instant disclosure.

Computer system 1500 also includes a memory 1514 that holds data for computer system 1500 or other components (or a combination of both) that may be connected to the network 1502. For example, memory 1514 may be a database storing data consistent with this disclosure. Although illustrated as a single memory 1514 in FIG. 11, two or more memories may be used according to particular needs, desires, or particular implementations of computer system 1500 and the described functionality. While memory 1514 is illustrated as an integral component of computer system 1500, in alternative implementations, memory 1514 may be external to computer system 1500.

In addition to holding data, the memory may be a non-transitory medium storing computer readable instruction capable of execution by computer processor 1512 and having the functionality for carrying out manipulation of the data including mathematical computations.

Application 1516 is an algorithmic software engine providing functionality according to particular needs, desires, or particular implementations of computer system 1500, particularly with respect to functionality described in this disclosure. For example, application 1516 can serve as one or more components, modules, applications, etc. Further, although illustrated as a single application 1516, application 1516 may be implemented as multiple applications 1516 on computer system 1500. In addition, although illustrated as integral to computer system 1500, in alternative implementations, application 1516 may be external to computer system 1500.

There may be any number of computers 1500 associated with, or external to, a computer system containing computer system 1500, each computer system 1500 communicating over network 1502. Further, the term “client,” “user,” and other appropriate terminology may be used interchangeably as appropriate without departing from the scope of this disclosure. Moreover, this disclosure contemplates that many users may use one computer system 1500, or that one user may use multiple computers 1500.

In some embodiments, computer system 1500 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

In conclusion, the present invention provides for novel systems, devices, and methods for providing location information for a tracking device. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A tracking system, the tracking system comprising:
a first monitor device comprising:
a movement determination circuit configured to generate an insignificant movement indication when the first monitor is moving less than a defined amount;
a second monitor device comprising:
a location determination circuit configured to determine a location of the second monitor device;
a transmitting circuit; and
a controller circuit configured to:
transmit the location to a receiving device using the transmitting circuit;
after transmitting the location to the receiving device, receive the insignificant movement indication from the first monitor device;
based at least in part upon the insignificant movement indication:
reduce power consumption of the location determination circuit; and
re-transmit the location to the receiving device using the transmitting circuit.

2. The system of claim 1, wherein the first monitor device is a user attached monitor device and the second monitor device is a user detached monitor device.

3. The system of claim 1, wherein the first monitor device is a user detached monitor device and the second monitor device is a user attached monitor device.

4. The system of claim 3, wherein the user attached monitor device further comprises a tamper detection circuit configured to detect removal of the user attached monitor device from the individual.

5. The system of claim 3, wherein the user detached monitor device is a cellular communication enabled device associated with a monitored individual, and wherein the user attached monitor device is configured for attachment to the monitored individual.

6. The system of claim 1, wherein the movement determination circuit comprises:
an accelerometer.

7. The system of claim 1, wherein the insignificant movement indication indicates that the first monitor device has moved less than a defined distance in a time period.

8. The system of claim 7, wherein the defined distance is less than fifty feet.

9. The system of claim 1, wherein the location determination circuit is selected from a group consisting of: a satellite-based position circuit; and a WiFi-based position circuit.

10. A method for tracking an individual, the method comprising:
receiving a location of a first monitor device from a location determination circuit in the first monitor device;
transmitting the location to a receiving device;
after transmitting the location, receiving an insignificant movement indication from a movement determination circuit in a second monitor device;
based at least in part upon the insignificant movement indication:
reducing power consumption of the location determination circuit; and
re-transmitting the location to the receiving device.

11. The method of claim 10, wherein the first monitor device is a user attached monitor device and the second monitor device is a user detached monitor device.

12. The method of claim 10, wherein the first monitor device is a user detached monitor device and the second monitor device is a user attached monitor device.

13. The method of claim 12, wherein the user attached monitor device further comprises a tamper detection circuit configured to detect removal of the user attached monitor device from the individual.

14. The method of claim 12, wherein the user detached monitor device is a cellular communication enabled device associated with a monitored individual, and wherein the user attached monitor device is configured for attachment to the monitored individual.

15. The method of claim 10, wherein the movement determination circuit comprises:
an accelerometer.

16. The method of claim 101, wherein the insignificant movement indication indicates that the first monitor device has moved less than a defined distance in a time period.

17. The method of claim 16, wherein the defined distance is less than fifty feet.

18. The method of claim 10, wherein the location determination circuit is selected from a group consisting of: a satellite-based position circuit; and a WiFi-based position circuit.

19. A tracking system, the tracking system comprising:
a first monitor device comprising:
a movement determination circuit configured to generate an insignificant movement indication when the first monitor is moving less than a defined amount;
a second monitor device comprising:
a location determination circuit configured to determine a location of the second monitor device;
a transmitting circuit; and
a processor and a computer readable medium communicatively coupled to the processor and including instructions which, when executed by the processor, cause the processor to:
transmit the location to a receiving device using the transmitting circuit;
after transmitting the location to the receiving device, receive the insignificant movement indication from the first monitor device;
based at least in part upon the insignificant movement indication:
reduce power consumption of the location determination circuit; and
re-transmit the location to the receiving device using the transmitting circuit.
